(19) United States
(12) Patent Application Publication
(10) Pub. No.: US 2008/0104747 A1
(43) Pub. Date: May 8, 2008

(54) SINK ORGANIZER AND SPLASH GUARD

(76) Inventor: Azanaw Mulaw, Fort Washington, MD (US)

Correspondence Address: STURM & FIX LLP, 206 SIXTH AVENUE, SUITE 1213, DES MOINES, IA, 50309-4076, US

(21) Appl. No.: 11/556,013

(22) Filed: Nov. 2, 2006

(51) Int. Cl. A47J 47/20

(52) U.S. Cl. 4/658

(57) ABSTRACT

A splash guard organizer for a sink work space. The splash guard organizer includes a vertical back panel with a number of spaced horizontal slots, a flexible water seal in contact with the rear portion of the sink top, and a hand access opening above the seal for operation of the water valve. The back panel is supported by a pair of feet extending forward from opposite ends of the panel. A number of fixtures, that have rearwardly extending tabs selectively secured in the slots, are supported in a cantilevered manner. The fixtures are designed to hold a number of individual items useful in the work space, such as bottles, brushes, sponges, towels and cleaning pads.

### BACKGROUND OF THE INVENTION

1. Field of the Invention

The present invention relates to the field of workplace organizers, and more particularly to a sink organizer and splash guard.

2. Description of Related Art

As can be seen by reference to the following D329,280; U.S. Pat. Nos. 4,722,103; 5,690,255; 6,653,395; and U.S. Publn. 20040099617, the prior art is replete with myriad and diverse workplace organizers.

While all of the aforementioned prior art constructions are more than adequate for the basic purpose and function for which they have been specifically designed, they are uniformly deficient with respect to their failure to provide a simple, efficient, and practical sink organizer and splash guard.

As a consequence of the foregoing situation, there has existed a longstanding need for a new and improved sink organizer and splash guard, and the provision of such a device is a stated objective of the present invention.

### BRIEF SUMMARY OF THE INVENTION

Briefly stated, the present invention provides a splash guard organizer for a sink work space. The splash guard organizer includes a vertical back panel with a number of spaced horizontal slots, a flexible water seal in contact with the rear portion of the sink top, and a hand access opening above the seal for operation of the water valve. The back panel is supported by a pair of feet extending forward from opposite ends of the panel. A number of fixtures, that have rearwardly extending tabs selectively secured in the slots, are supported in a cantilevered manner. The fixtures are designed to hold a number of individual items useful in the work space, such as bottles, brushes, sponges, towels, and cleaning pads.

### BRIEF DESCRIPTION OF THE SEVERAL VIEWS OF THE DRAWINGS

These and other attributes of the invention will become more clear upon a thorough study of the following description of the best mode for carrying out the invention, particularly when reviewed in conjunction with the drawings, wherein:

FIG. 1 is a perspective view of the splash guard organizer of the present invention;

FIG. 2 is a front elevational view thereof;

FIG. 3 is a side elevation sectional view taken along line 3-3 of FIG. 2;

FIG. 4 is a partial perspective view illustrating how one of the fixtures is secured to the back panel;

FIG. 5 is a side elevational view thereof; and

FIG. 6 is a partial perspective view illustrating the attachment of the support feet to one end of the back panel.

### DETAILED DESCRIPTION OF THE INVENTION

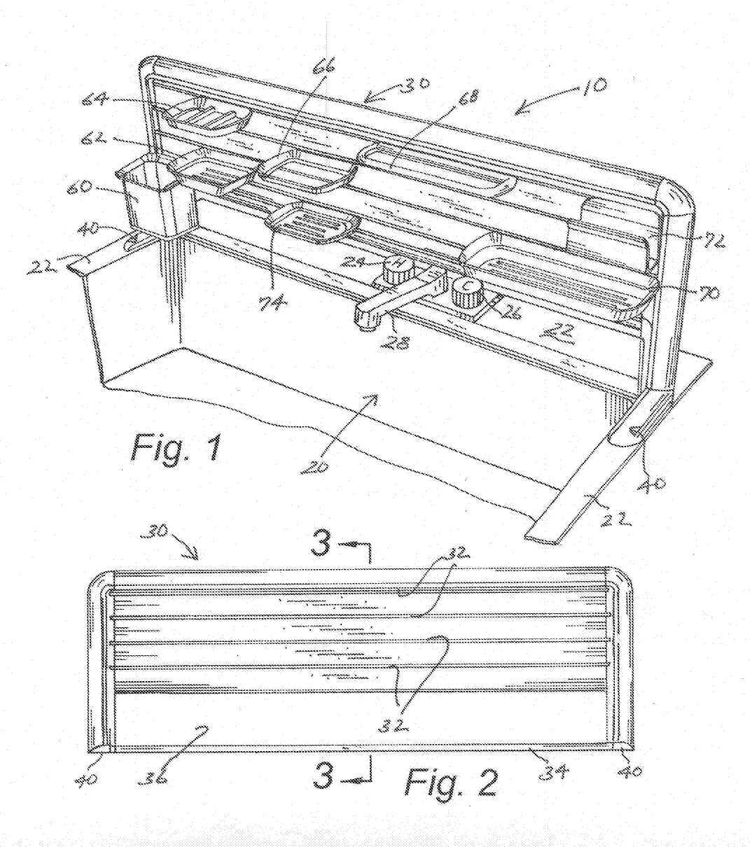

As can be seen by reference to the drawings, and in particular to FIG. 1, the sink organizer and splash guard that forms the basis of the present invention is designated generally by the reference number 10.

The splash guard organizer 10 shown in the drawings is specifically designed for a sink work space environment where the sink 20 has a peripheral top surface 22, water valves 24 and 26, and a faucet 28. It is to be understood that the organizer 10 could be used in other work space environments, or be specifically designed for other environments, such as a hobby sewing room, garage work center, laboratories, and home or business offices.

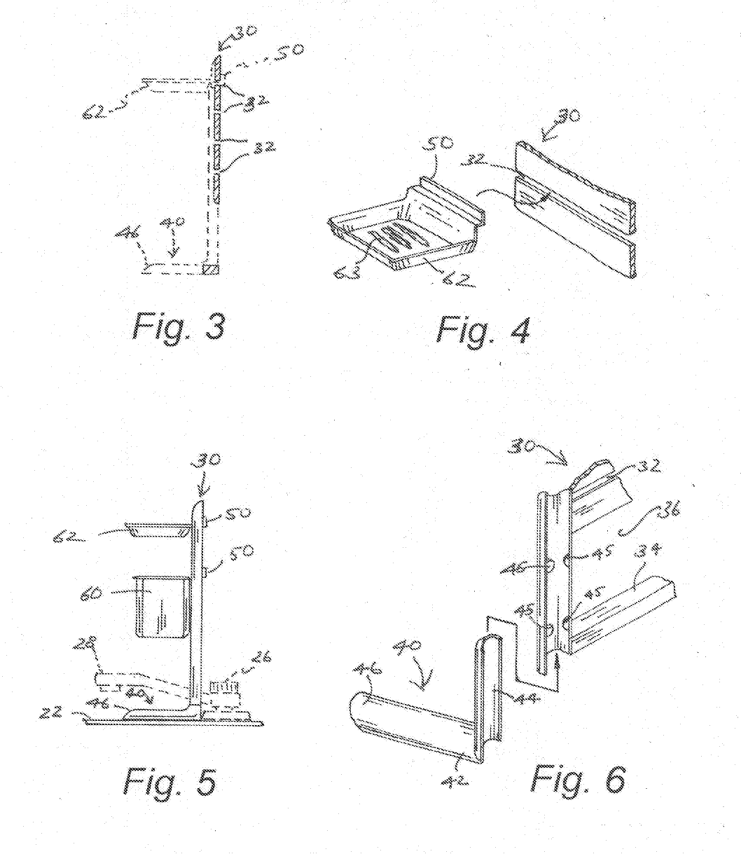

As most clearly shown in FIGS. 2 and 3, the organizer 10 has a thin vertically disposed back panel 30 that includes a number of vertically spaced horizontal slots 32, a flexible bottom seal 34, and a hand access opening 36. The back panel 30 is supported in its vertical position by a pair of forwardly extending feet 40 that are attached at each end of the back panel 30 by a frictional snap fitting, as illustrated in FIG. 6. The back end 42 of the feet 40 has an upwardly extending member 44 that selectively engages the bosses 45 on the back side of the panel 30. The forwardly extending free end 46 of the feet 40 rests on a side portion of the sink top surface 22 to stabilize the back panel 30 in its vertical position.

As best shown in FIGS. 1, 4, and 5, a number of fixtures are selectively attached to the back panel 30 in a cantilevered manner. Each of the fixtures has a tab 50 at the rear that engages a section of one of the slots 32 in the back panel 30. It is to be understood that the individual fixtures may be arranged on the back panel 30 in any position suitable to the user.

The individual fixtures shown in FIG. 1 include a deep dish 60, a shallow dish 62, a divided ring 64, and undivided ring 66, a wash towel rack 68, a wide dish 70, a sponge rack 72, and a flat dish 74.

The deep dish 60 holds liquid soap bottles, cleaning brushes or other items that may require a deep retaining wall.

The shallow dish 62 either functions as a platform to support liquid soap bottles and cleaning brushes, or a dish to hold all bar of soap, a sponge, a cleaning pad, or other items that may not require a deeper retaining wall, but still requires some method of retention. In combination with the divided ring 64 above, it could also support cutlery or dining utensils.

The divided ring 64 in combination with the shallow dish 62 or flat dish 74 directly below can hold dining utensils, cleaning brushes or other items requiring a deep partitioned retaining wall.

The undivided ring 66 in combination with either the shallow dish 62 or flat dish 74 directly below is an alternate to the deep dish 60 and can hold a liquid soap bottle, cleaning brushes or other items that may require a retaining ring.

The wash towel rack 68 provides a place to suspend wash towels and cleaning rags.

The wide dish 70 provides storage space for sponges, bars of soap, cleaning pads, smaller liquid soap bottles, or cleaning brushes laid on their sides.

The sponge rack 72 allows a sponge or cleaning pad to be stored in a fashion that will allow for more effective drainage.

The flat dish 74 holds items similar to the shallow dish 62, but provides for increased access to its contents for easy retrieval and replacement. It could also serve as a platform in combination with the divided and undivided rings 64 and 66.

It is to be understood that other specific fixtures could be provided, and that openings 63 (FIG. 4) may be provided in the fixtures to allow proper drainage. Also, the back panel 30 and the fixtures may be constructed of translucent material to provide a brighter work area.

Although only an exemplary embodiment of the invention has been described in detail above, those skilled in the art will readily appreciate that many modifications are possible without materially departing from the novel teachings and advantages of this invention. Accordingly, all such modifications are intended to be included within the scope of this invention as defined in the following claims.

Having thereby described the subject matter of the present invention, it should be apparent that many substitutions, modifications, and variations of the invention are possible in light of the above teachings. It is therefore to be understood that the invention as taught and described herein is only to be limited to the extent of the breadth and scope of the appended claims.

1. A splash guard organizer for a sink having a peripheral top surface and a water flow control valve extending up from a rear portion of the top surface, the organizer comprising:
a vertically disposed back panel having a plurality of vertically spaced horizontally disposed slots, the back panel including a flexible seal disposed in sealing contact with the rear portion of the top surface of the sink forward of the water valve, and a band access opening disposed above the seal forward of the water valve;
a pair of support feet each of the feet having one end attached to a bottom section of the panel, and another free end extending forward of the panel, the support feet being in contact with opposing side portions of the top surface of the sink, whereby the back panel is stabilized and supported in a vertical position; and
a plurality of fixtures, each of the fixtures having a rearwardly extending tab disposed to selectively engage a section of one of the plurality of slots to support each of the fixtures in a cantilevered manner extending forward of the back panel.

2. The organizer of claim 1 wherein the back panel is formed of translucent material.

3. The organizer of claim 1 wherein at least one of the plurality of fixtures includes drain openings to prevent water from accumulating in the at least one fixture.

4. The organizer of claim 1 wherein the support feet are attached to the back panel by a frictionally secured snap fitting.

5. The organizer of claim 1 wherein at least one of the plurality of fixtures comprises a wash towel rack.

6. The organizer of claim 1 wherein at least one of the plurality of fixtures comprises a ring.

7. The organizer of claim 1 wherein at least one of the plurality of fixtures comprises a divided ring.

8. The organizer of claim 1 wherein at least one of the plurality of fixtures comprises a flat dish.

9. The organizer of claim 1 wherein at least one of the plurality of fixtures comprises a shallow dish.

10. The organizer of claim 1 wherein at least one of the plurality of fixtures comprises a deep dish.

11. The organizer of claim 1 wherein at least one of the plurality of fixtures comprises a wide dish.

12. The organizer of claim 1 wherein at least one of the plurality of fixtures comprises a sponge rack.
